(19) United States
(12) Patent Application Publication
(10) Pub. No.: US 2012/0269139 A1
(43) Pub. Date: Oct. 25, 2012

(54) Control Method and System for Non-Serving Uplink Enhanced Radio Link of Dual-Carrier System

(75) Inventors: Yu Zhang, Shenzhen (CN); Xiang Cheng, Shenzhen (CN)

(73) Assignee: ZTE CORPORATION, Shenzhen City, Guangdong Province (CN)

(21) Appl. No.: 13/391,731

(22) PCT Filed: Aug. 27, 2010
(86) PCT No.: PCT/CN2010/076427

§ 371 Date: Feb. 22, 2012

(30) Foreign Application Priority Data
Jan. 11, 2010 (CN) 201010001626.6

(51) Int. Cl. H04W 72/04

(52) U.S. Cl. 370/329

(57) ABSTRACT

A method for controlling non-serving uplink enhanced radio link of dual carrier system is provided, which includes: a radio network controller informing a non-serving Node B to which the terminal using the dual carrier high speed packet access technology belongs of the carrier attribute information of the enhanced radio link; and the non-serving Node B controlling the enhanced radio link according to the carrier attribute information. A system for controlling non-serving uplink enhanced radio link of dual carrier system and a radio network controller is provided. The control method can make the terminal establish an uplink enhanced dedicated channel according to the carrier attribute information of the radio link, and realize the practicable application of the dual carrier technology by tiny modifications in the special scenarios, thereby making the dual carrier high speed packet access technology practicable.

### TECHNICAL FIELD

The present invention relates to a radio communication system, and more especially, to a method and a system for controlling non-serving uplink enhanced radio link in a dual carrier system.

### BACKGROUND OF THE RELATED ART

In the radio communication system, a radio link refers to a logical connection between a terminal and an access point of radio access system, and is generally comprised of one or multiple radio bearer transmissions in the physical implementation. There is at most one radio link between the terminal and the access point of radio access system (which generally refers to a cell). An Interconnection of type B (IUB for short) interface is a logical interface between a Radio Network Controller (RNC for short) and Node B, and an Interconnection of RNC (IUR for short) interface (an interconnection interface between RNCs) is an interface used by the RNC for performing the interaction of signaling and data with other RNCs and it is an interconnection bond between radio network subsystems.

In the radio communication system, a Node B Application Part (NBAP for short) is that: a protocol framework of IUB interface is composed of two function layers, namely: a radio network layer and a transmission layer. The NBAP is a part of the radio network layer of IUB interface and specifies the functional behavior of the Node B correctly and completely. A Radio Network Subsystem Application Part (RNSAP for short) is a dedicated protocol of IUR interface for completing the mobility management of terminal connected with the radio network controller across radio network subsystem, which comprises functions such as handover, radio resource processing and synchronization and so on between radio network subsystems.

A Radio link management function refers to a Control Radio Network Controller (CRNC for short) controlling the dedicated resource of Node B through a radio link control process, which relates to the basic processes of dedicated resource setup and deletion, including a “radio link establishment” control process, “radio link increment” control process, “radio link synchronous reconfiguration” and “radio link asynchronous reconfiguration”, etc. A Radio Link Identity (RL ID for short) is a unique identity of the radio link related to the terminal. Therefore, the RL ID is used as a unified resource identity between the radio network controller, the Node B and terminal in the radio link control process.

A radio network control entity comprises a Node B and a radio network controller. With regard to the radio network controller, when a terminal establishes a connection to the radio access network and generates a soft handover at the IUR interface, resources of more than one radio network controllers will be used.

The radio network controller further comprises a Serving Radio Network Controller (SRNC for short) and a Drift Radio Network Controller (DRNC for short) besides a control radio network controller, wherein the SRNC is a radio network controller for maintaining an interface connection of terminal and core network. The DRNC is the other radio network controllers except the SRNC. The number of DRNCs of one terminal can be more than one.

In the existing system, the purpose of the high speed uplink packet access technology is to improve the capacity and data throughput in the uplink direction and reduce the delay in a dedicated channel. The high speed uplink packet access technology introduces a new transmission channel: an Enhanced Dedicated Channel (E-DCH for short), which performs an improvement on the implementation of physical layer and media access control layer and can reach a maximum theoretical uplink data rate of 5.6 megabits per second. The high speed uplink packet access technology keeps the features of the soft handover, and with regard to a terminal, there will be an activated set of the E-DCH if a soft handover occurs.

With the development of technology, the dual carrier high speed uplink packet access technology (which makes the terminal can send data by the high speed uplink packet access technology on two carriers, so that the uplink data rate is increased at the double) is expected to be introduced into the existing system. In addition, the dual carrier high speed uplink packet access technology and existing dual carrier high speed downlink packet access technology are bound for usage, which are called dual carrier technology. The application scenario of dual carrier technology comprises: uplink single carrier high speed uplink packet access technology and downlink single carrier high speed downlink packet access technology; uplink single carrier high speed uplink packet access technology and downlink dual carrier high speed downlink packet access technology; uplink dual carrier high speed uplink packet access technology and downlink dual carrier high speed downlink packet access technology.

The dual carrier in the dual carrier technology comprises: a carrier of the High-Speed Dedicated Physical Control Channel (HS-DPCCH for short), which is called as a main carrier, and the other one in the dual carrier is called as an auxiliary carrier. With regard to one terminal, the carrier of each layer in the dual carrier has its own independent activated set of enhanced dedicated channel. On the frequency corresponding to the main carrier and in the activated set of enhanced dedicated channel of the main carrier, the Node B to which the serving enhanced dedicated channel radio link of the main carrier belongs is called as a serving Node B, and the other Nodes B are called as non-serving Nodes B. Similarly, on the frequency corresponding to the auxiliary carrier and in the activated set of enhanced dedicated channel of the auxiliary carrier, the Node B to which the serving enhanced dedicated channel radio link of the auxiliary carrier belongs is called as a serving Node B, and the other Nodes B are called as non-serving Nodes B. The radio links belonging to the non-serving Nodes B can only correspond to the uplink main carrier or uplink auxiliary carrier, thus a scenario of establishing a non-serving uplink enhanced dedicated channel radio link appears in the condition that there is no corresponding non-serving downlink high speed shared channel radio link.

In the radio link control process, when the serving downlink shared channel radio links are established or increased, the uplink enhanced dedicated channel radio links belonging to the same carrier layer (the main carrier layer or the auxiliary carrier layer) are established or increased correspondingly, and the frequency information controlled by the uplink enhanced dedicated channel radio link can refer to downlink high speed shared channel radio link corresponding to the uplink enhanced dedicated channel radio link. However, according to the current technology and standardized processing protocol, and with regard to the non-serving uplink enhanced radio link, there is such a problem: a control can't be performed on the non-serving uplink enhanced dedicated channel radio link in the condition that there is no corresponding non-serving downlink high speed shared channel radio link.

### SUMMARY OF THE INVENTION

The technical problem to be solved by the present invention is to provide a control method and system for non-serving uplink enhanced radio link of dual carrier system.

In order to solve the foregoing problem, the present invention provides a method for controlling non-serving uplink enhanced radio link of dual carrier system, which comprises:
in a process of a non-serving cell performing a control of an enhanced radio link on a terminal using dual carrier high speed packet access technology, a radio network controller informing a non-serving Node B to which the terminal belongs of carrier attribute information of the enhanced radio link; and
the non-serving Node B performing the control of the enhanced radio link according to the carrier attribute information.

The step of the radio network controller informing the non-serving Node B of the carrier attribute information of the enhanced radio link comprises:
a serving radio network controller sending the carrier attribute information of the enhanced radio link to a drift radio network controller through a radio link management signaling of Radio Network Subsystem Application Part (RNSAP) protocol layer via an Interconnection of RNC (IUR) interface; and
the drift radio network controller sending the carrier attribute information of the enhanced radio link to a non-serving Node B through a radio link management signaling of Node B Application Part (NBAP) protocol layer via an Interconnection of type B (IUB) interface.

The step of the radio network controller informing the non-serving Node B of the carrier attribute information of the enhanced radio link comprises:
a serving radio network controller sending the carrier attribute information of the enhanced radio link to the non-serving Node B through the radio link management signaling of the Node B Application Part (NBAP) protocol layer via the Interconnection of type B (IUB) interface.

The carrier attribute information is configured to indicate that a carrier in which the enhanced radio link is located belongs to a main carrier or an auxiliary carrier in a dual carrier.

When the control process is a radio link establishment process, the control performed by the non-serving Node B on the radio link is: establishing the enhanced radio link.

When the control process is a radio link increment process, the control performed by the non-serving Node B on the radio link is: increasing the enhanced radio link.

When the control process is a radio link synchronous reconfiguration process, the control performed by the non-serving Node B on the radio link is: reconfiguring the enhanced radio link synchronously.

When the control process is a radio link asynchronous reconfiguration process, the control performed by the non-serving Node B on the radio link is: reconfiguring the enhanced radio link asynchronously.

In the step of the radio network controller informing the non-serving Node B to which the terminal belongs of the carrier attribute information of the enhanced radio link, the radio network controller also informs the non-serving Node B of identity information of the enhanced radio link to be controlled.

In order to solve the foregoing problem, the present invention provides a system for controlling non-serving uplink enhanced radio link of dual carrier system, which comprises a radio network controller and a non-serving Node B, wherein,
the radio network controller is configured to: inform a non-serving Node B to which a terminal belongs of carrier attribute information of an enhanced radio link in a process of a non-serving cell performing a control of an enhanced radio link on a terminal using dual carrier high speed packet access technology;
the non-serving Node B is configured to: perform control of the enhanced radio link according to the carrier attribute information.

In order to solve the foregoing problem, the present invention also provides a radio network controller, which is configured to:
inform a non-serving Node B to which a terminal belongs of carrier attribute information of an enhanced radio link in a process of a non-serving cell performing a control of an enhanced radio link on a terminal using dual carrier high speed packet access technology, so that the non-serving Node B implements the control of the enhanced radio link according to the carrier attribute information.

When the radio network controller is a Serving Radio Network Controller (SRNC), the SRNC is further configured to: send carrier attribute information of the enhanced radio link to a Drift Radio Network Controller (DRNC) through a radio link management signaling of Radio Network Subsystem Application Part (RNSAP) protocol layer via an Interconnection of RNC (IUR) interface, so that the DRNC informs a non-serving Node B to which the terminal belongs of the carrier attribute information of the enhanced radio link, and
when the radio network controller is a DRNC, the DRNC is further configured to: send the carrier attribute information of the enhanced radio link to a non-serving Node B through a radio link management signaling of Node B Application Part (NBAP) protocol layer via an Interconnection of type B (IUB) interface.

The radio network controller is configured to: inform the non-serving Node B of the carrier attribute information of the enhanced radio link according to the following ways:
a serving radio network controller sending the carrier attribute information of the enhanced radio link to the non-serving Node B through the radio link management signaling of the Node B Application Part (NBAP) protocol layer via an Interconnection of type B (IUB) interface.

The carrier attribute information is configured to indicate that a carrier in which the enhanced radio link is located belongs to a main carrier or an auxiliary carrier in a dual carrier.

The radio network controller is further configured to: inform the non-serving Node B of identity information of the enhanced radio link to be controlled.

The present invention performs the transmission and acquisition of the carrier attribute information of the radio link between the radio access network control entities through including the carrier attribute information of a specified radio link in the signaling of the radio link control process, so that the terminal can establish an uplink enhanced dedicated channel according to the carrier attribute information of the radio link, and solve the practicable application of the dual carrier technology in the special scenarios by tiny modifications, thereby avoiding the defects in the existing technology and making the dual carrier high speed packet access technology practicable.

### BRIEF DESCRIPTION OF DRAWINGS

FIG. 1 is a schematic diagram of the setting scenarios of examples according to the present invention;

FIG. 2 is a schematic diagram of the example 1 according to the present invention;

FIG. 3 is a schematic diagram of the example 2 according to the present invention;

FIG. 4 is a schematic diagram of the example 3 according to the present invention;

FIG. 5 is a schematic diagram of the example 4 according to the present invention;

FIG. 6 is a schematic diagram of the example 5 according to the present invention;

FIG. 7 is a schematic diagram of the example 6 according to the present invention;

FIG. 8 is a schematic diagram of the example 7 according to the present invention;

FIG. 9 is a schematic diagram of the example 8 according to the present invention.

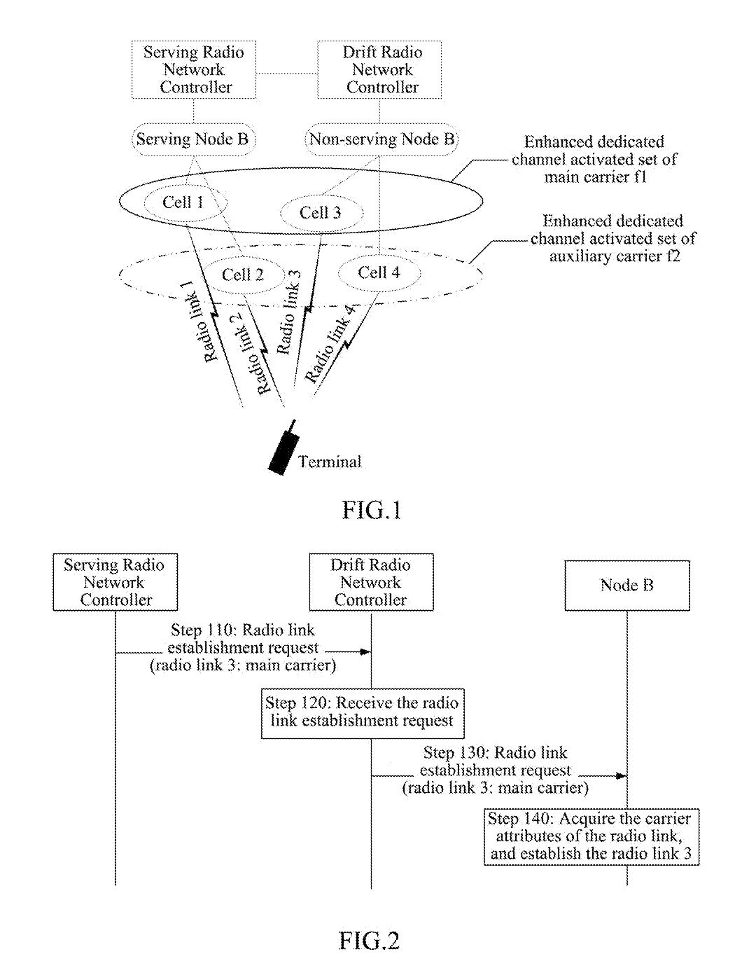

### PREFERRED EMBODIMENTS OF THE PRESENT INVENTION

As described in the part of background of the related art, the control can't be performed on the non-serving uplink enhanced dedicated channel radio link in the condition that there is no corresponding non-serving downlink high speed shared channel radio link, which is because there is no referable frequency information when controlling the non-serving uplink enhanced dedicated channel radio link. Therefore, when a non-serving Node B receives a related signaling for controlling the non-serving uplink enhanced channel radio link, it is puzzling whether the operation should be performed in the layer of the main carrier or in the layer of the auxiliary carrier.

The inventive concept of the present invention is: in a process of a non-serving cell performing a control of an enhanced radio link on a terminal using dual carrier high speed packet access technology, a radio network controller informing a non-serving Node B to which the terminal belongs of the carrier attribute information of the enhanced radio link, and the non-serving Node B implement a control on the enhanced radio link according to the carrier attribute information.

An enhanced radio link refers to an uplink radio link corresponding to the enhanced dedicated channel. The above enhanced radio link is a radio link object of specified operation in the radio link control process.

The carrier attribute information of the enhanced radio link is used for indicating that the carrier in which the enhanced radio link is located belongs to a main carrier or an auxiliary carrier in the dual carrier.

The above control process comprises one of the following processes: radio link establishment process, radio link increment process, radio link synchronous reconfiguration process and radio link asynchronous reconfiguration process. Correspondingly, the control performed by the non-serving Node B on the radio link comprises: establishing an enhanced radio link, increasing an enhanced radio link, synchronous reconfiguration enhanced radio link and asynchronous reconfiguration enhanced radio link.

The step of the radio network controller informing the non-serving Node B of the carrier attribute information of the enhanced radio link comprises: a serving radio network controller informs a non-serving Node B which the terminal belongs to of the carrier attribute information of the enhanced radio link through a radio link management signaling. In a scenario of a drift radio network controller existing as a relay, the serving radio network controller sends the carrier attribute information of the enhanced radio link to a non-serving Node B through the drift radio network controller, and the signaling adopted by the serving radio network controller is a radio link management signaling, which is specifically:

When the radio link control process is a radio link establishment process, a serving radio network controller (SRNC) sends a “radio link establishment request” signaling to a drift radio network controller (DRNC) through RNSAP protocol layer via an IUR interface, and the “radio link establishment request” signaling includes the carrier attribute information of the enhanced radio link, and the DRNC forwards the radio link establishment request signaling including the carrier attribute information to a non-serving Node B through NBAP protocol layer via an IUB interface. Refer to the example 1.

When the radio link control process is a radio link establishment process, a SRNC sends a “radio link establishment request” signaling to a non-serving Node B through NBAP protocol layer via an IUB interface, and the “radio link establishment request” signaling includes the carrier attribute information of the enhanced radio link. Refer to the example 2.

When the radio link control process is a radio link increment process, a SRNC sends a “radio link increment request” signaling to a DRNC through RNSAP protocol layer via an IUR interface, and the “radio link increment request” signaling includes the carrier attribute information of the enhanced radio link, and the DRNC forwards the “radio link increment request” signaling including the carrier attribute information to a non-serving Node B through NBAP protocol layer via an IUB interface. Refer to the example 3.

When the radio link control process is a radio link increment process, a SRNC sends a “radio link increment request” signaling to a non-serving Node B through NBAP protocol layer via an IUB interface, and the “radio link increment request” signaling includes the carrier attribute information of the enhanced radio link. Refer to the example 4.

When the radio link control process is a radio link synchronous reconfiguration process, a SRNC sends a “radio link reconfiguration preparation” signaling to a DRNC through RNSAP protocol layer via an IUR interface, and the “radio link reconfiguration preparation” signaling includes the carrier attribute information of the enhanced radio link, and the DRNC forwards the “radio link reconfiguration preparation” signaling including the carrier attribute information to a non-serving Node B through NBAP protocol layer via an IUB interface. Refer to the example 5.

When the radio link control process is a radio link synchronous reconfiguration process, a SRNC sends a “radio link reconfiguration preparation” signaling to a non-serving Node B through NBAP protocol layer via an IUB interface, and the “radio link reconfiguration preparation” signaling includes the carrier attribute information of the enhanced radio link. Refer to the example 6.

When the radio link control process is a radio link asynchronous reconfiguration process, a SRNC sends a “radio link reconfiguration request” signaling to a DRNC through RNSAP protocol layer via an IUR interface, and the “radio link reconfiguration request” signaling includes the carrier attribute information of the enhanced radio link, and the DRNC forwards the “radio link reconfiguration request” signaling including the carrier attribute information to a non-serving Node B through NBAP protocol layer via an IUB interface. Refer to the example 7.

When the radio link control process is a radio link asynchronous reconfiguration process, a SRNC sends a “radio link reconfiguration request” signaling to a non-serving Node B through NBAP protocol layer via an IUB interface, and the “radio link reconfiguration request” signaling includes the carrier attribute information of the enhanced radio link. Refer to the example 8.

When performing the radio link control process on the terminal, the radio network controller also informs the non-serving Node B of the identity information of the enhanced radio link to be controlled, thereby indicating the radio link to be controlled by the non-serving Node B.

Below the present invention will be further described with reference to drawings and specific examples, and the Nodes B in the following examples all refer to the non-serving Nodes B of the terminal using dual carrier high speed packet access technology.

### Example 1

As shown in FIG. 2, the example 1 is a process of: when the radio link control process is a radio link establishment process, a serving radio network controller (SRNC) sending a “radio link establishment request” signaling to a drift radio network controller (DRNC) through RNSAP protocol layer via an IUR interface, and the DRNC sending the “radio link establishment request” signaling to a Node B through NBAP protocol layer via an IUB interface, which comprises the following steps.

Step 110: when performing a radio link establishment, a SRNC sends a “radio link establishment request” signaling to a DRNC, and informs the DRNC of the carrier attribute information of the carrier in which the established enhanced radio link is located and the identity information of the enhanced radio link to be established;
in the example, the carrier attribute information of the carrier in which the enhanced radio link is located comprises a main carrier, and a radio link identity is 3. The radio link establishment request indicates the DRNC to establish an enhanced radio link with an identity to be 3 on the main carrier.

Step 120: the DRNC receives the “radio link establishment request” signaling. Step 130: the DRNC forwards the “radio link establishment request” signaling including the carrier attribute and identity information of the radio link to the Node B, thereby indicating the Node B to establish the enhanced radio link;
the radio link establishment request indicates the Node B to establish the enhanced radio link with an identity to be 3 on the main carrier.

Step 140: the Node B establishes the enhanced radio link with an identity to be 3 on the main carrier after receiving the “radio link establishment request” signaling.

The step of the Node B establishing the enhanced radio link with an identity to be 3 on the main carrier refers to: a Node B commanding the terminal to establish an enhanced radio link on the main carrier.

As informed of the carrier attribute information of the enhanced radio link, the Node B can indicate the terminal to establish the enhanced radio link on the main carrier, thereby avoiding the defect that an non-serving uplink enhanced dedicated channel radio link can't be established, for there is no non-serving downlink high speed shared channel radio link in the existing technology.

### Example 2

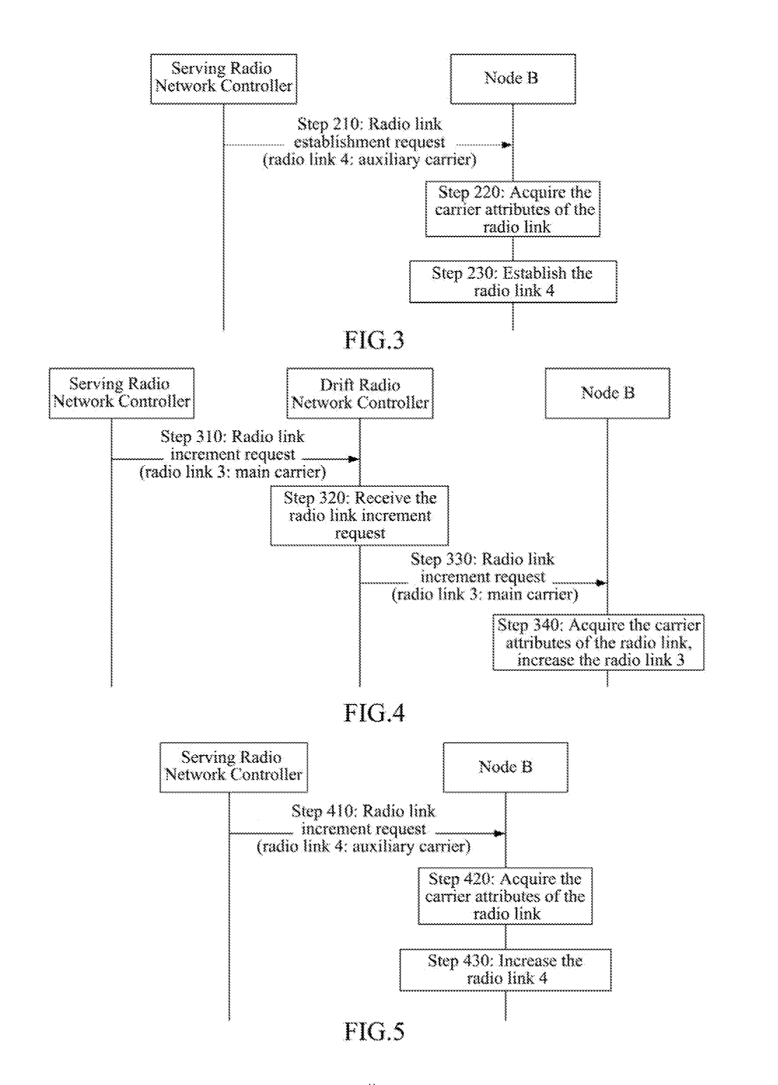

As shown in FIG. 3, the example 2 is a process of: when the radio link control process is a radio link establishment process, a serving radio network controller (SRNC) sending a “radio link establishment request” signaling to a Node B through NBAP protocol layer via an IUB interface, which comprises the following steps.

Step 210: when performing a radio link establishment, a SRNC sends a “radio link establishment request” signaling to a Node B, and informs the Node B of the carrier attribute information of the carrier in which the established enhanced radio link is located and the identity information of the enhanced radio link to be established;
in the example, the carrier attribute information of the carrier in which the enhanced radio link is located comprises an auxiliary carrier, and a radio link identity is 4. The radio link establishment request indicates the Node B to establish an enhanced radio link with an identity to be 4 on the auxiliary carrier.

Step 220: the Node B receives the “radio link establishment request” signaling, and obtains the carrier attribute information and the identity information of the radio link therein.

Step 230: the Node B establishes the enhanced radio link with an identity to be 4 on the auxiliary carrier according to the obtained information.

The step of the Node B establishing the enhanced radio link with an identity to be 4 on the auxiliary carrier refers to: a Node B commanding the terminal to establish an enhanced radio link on the auxiliary carrier.

As informed of the carrier attribute information of the radio link, the Node B can indicate the terminal to establish the enhanced radio link on the auxiliary carrier, thereby avoiding the defect that an non-serving uplink enhanced dedicated channel radio link can't be established, for there is no non-serving downlink high speed shared channel radio link in the existing technology.

### Example 3

As shown in FIG. 4, the example 3 is a process of: when the radio link control process is a radio link increment process, a serving radio network controller (SRNC) sending a “radio link increment request” signaling to a drift radio network controller (DRNC) through RNSAP protocol layer via an IUR interface, and the DRNC sending the “radio link increment request” signaling to a Node B through NBAP protocol layer via an IUB interface, which comprises the following steps.

Step 310: when performing a radio link increment, a SRNC sends a “radio link increment request” signaling to a DRNC, and informs the DRNC of the carrier attribute information of the carrier in which the increased enhanced radio link is located and the identity information of the enhanced radio link to be established;
in the example, the carrier attribute information of the carrier in which the enhanced radio link is located comprises a main carrier, and a radio link identity is 3. The radio link increment request indicates the DRNC to increase an enhanced radio link with an identity to be 3 on the main carrier.

Step 320: the DRNC receives the “radio link increment request” signaling.

Step 330: the DRNC forwards the “radio link increment request” signaling including the carrier attribute and the identity information of the radio link to the Node B, and indicates the Node B to increase the enhanced radio link;
the radio link increment request indicates the Node B to increase the enhanced radio link with an identity to be 3 on the main carrier.

Step 340: the Node B increases the enhanced radio link with an identity to be 3 on the main carrier after receiving the “radio link increment request” signaling.

The step of the Node B increasing the enhanced radio link with an identity to be 3 on the main carrier refers to: a Node B commanding the terminal to increase an enhanced radio link on the main carrier.

As obtaining the carrier attribute information of the radio link, the Node B can indicate the terminal to increase the enhanced radio link on the main carrier, thereby avoiding the defect that an non-serving uplink enhanced dedicated channel radio link can't be increased, for there is no non-serving downlink high speed shared channel radio link in the existing technology.

### Example 4

As shown in FIG. 5, the example 4 is a process of: when the radio link control process is a radio link increment process, a serving radio network controller (SRNC) sending a “radio link increment request” signaling to a Node B through NBAP protocol layer via an IUB interface, which comprises the following steps.

Step 410: when performing a radio link establishment, a SRNC sends a “radio link increment request” signaling to a Node B, and informs the Node B of the carrier attribute information of the carrier in which the established enhanced radio link is located and the identity information of the enhanced radio link to be established;
in the example, the carrier attribute information of the carrier in which the enhanced radio link is located comprises an auxiliary carrier, and a radio link identity is 4. The radio link increment request indicates the Node B to increase an enhanced radio link with an identity to be 4 on the auxiliary carrier.

Step 420: the Node B receives the “radio link increment request” signaling, and obtains the carrier attribute and the identity information of the radio link therein.

Step 430: the Node B increases the enhanced radio link with an identity to be 4 on the auxiliary carrier according to the obtained information.

The step of the Node B increasing the enhanced radio link with an identity to be 4 on the auxiliary carrier refers to: a Node B commanding the terminal to increase an enhanced radio link on the auxiliary carrier.

As informed of the carrier attribute information of the enhanced radio link, the Node B can indicate the terminal to increase the enhanced radio link on the auxiliary carrier, thereby avoiding the defect that an non-serving uplink enhanced dedicated channel radio link can't be increased, for there is no non-serving downlink high speed shared channel radio link in the existing technology.

### Example 5

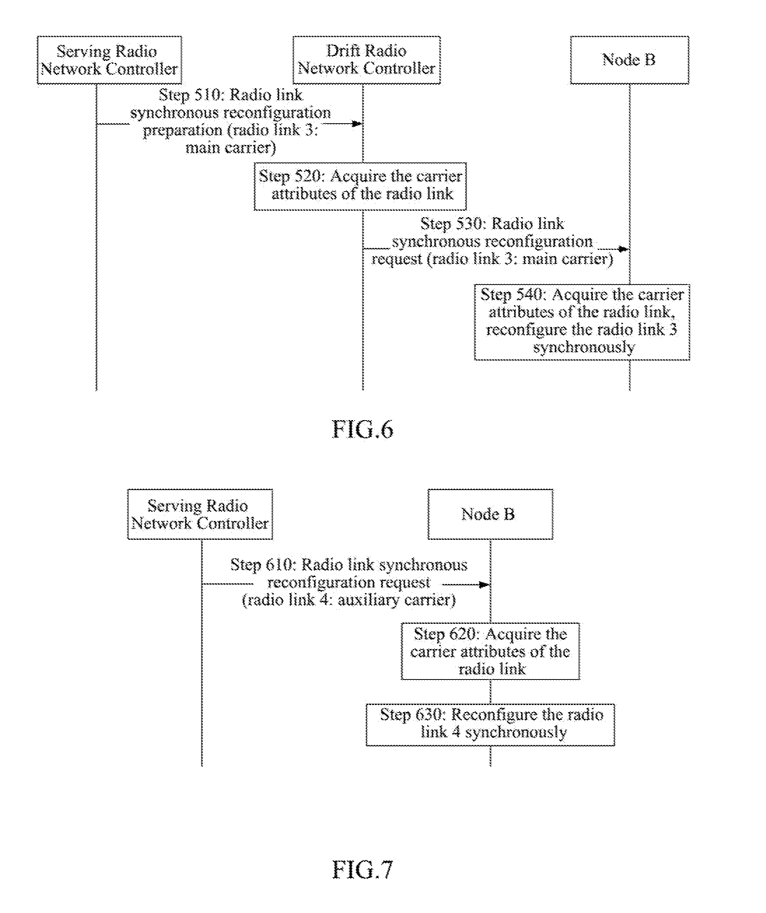

As shown in FIG. 6, the example 5 is a process of: when the radio link control process is a radio link synchronous reconfiguration process, a serving radio network controller (SRNC) sending a “radio link synchronous reconfiguration preparation” signaling to a drift radio network controller (DRNC) through RNSAP protocol layer via an IUR interface, and the DRNC sending a “radio link synchronous reconfiguration request” signaling to a Node B through NBAP protocol layer via an IUB interface, which comprises the following steps.

Step 510: when performing the radio link synchronous reconfiguration, a SRNC sends a “radio link synchronous reconfiguration preparation” signaling to a DRNC, and informs the DRNC of the carrier attribute information of the carrier in which the synchronously reconfigured enhanced radio link is located and the identity information of the enhanced radio link to be reconfigured;
in the example, the carrier attribute information of the carrier in which the enhanced radio link is located comprises a main carrier, and a radio link identity is 3. The radio link synchronous reconfiguration preparation signaling indicates the DRNC to synchronously reconfigure an enhanced radio link with an identity to be 3 on the main carrier.

Step 520: the DRNC receives the “radio link synchronous reconfiguration preparation” signaling, obtains the carrier attribute and the identity of the radio link therein, and constructs a “radio link synchronous reconfiguration request” signaling.

Step 530: the DRNC sends the “radio link synchronous reconfiguration request” signaling including the carrier attribute and the identity information of the radio link to the Node B, and indicates the Node B to synchronously reconfigure the enhanced radio link;
the radio link synchronous reconfiguration request signaling indicates the Node B to synchronously reconfigure the enhanced radio link with an identity to be 3 on the main carrier.

Step 540: the Node B synchronously reconfigures the enhanced radio link with an identity to be 3 on the main carrier after receiving the “radio link synchronous reconfiguration request” signaling.

The step of the Node B synchronously reconfiguring the enhanced radio link with an identity to be 3 on the main carrier refers to: a Node B commanding the terminal to synchronously reconfigure an enhanced radio link on the main carrier.

As informed of the carrier attribute information of the radio link, the Node B can indicate the terminal to synchronously reconfigure the enhanced radio link on the main carrier, thereby avoiding the defect that an non-serving uplink enhanced dedicated channel radio link can't be synchronously reconfigured, for there is no non-serving downlink high speed shared channel radio link in the existing technology.

### Example 6

As shown in FIG. 7, the example 6 is a process of: when the radio link control process is a radio link synchronous reconfiguration process, a serving radio network controller (SRNC) sending a “radio link synchronous reconfiguration request” signaling to a Node B through NBAP protocol layer via an IUB interface, which comprises the following steps.

Step 610: when performing the radio link synchronous reconfiguration, a SRNC sends a “radio link synchronous reconfiguration request” signaling to a Node B, and informs the Node B of the carrier attribute information of the carrier in which the synchronously reconfigured enhanced radio link is located and the identity information of the enhanced radio link to be reconfigured;
in the example, the carrier attribute information of the carrier in which the enhanced radio link is located comprises an auxiliary carrier, and a radio link identity is 4. The radio link synchronous reconfiguration request signaling indicates the Node B to synchronously reconfigure an enhanced radio link with an identity to be 4 on the auxiliary carrier.

Step 620: the Node B receives the “radio link synchronous reconfiguration request” signaling, and obtains the carrier attribute and the identity information of the radio link therein.

Step 630: the Node B synchronously reconfigures the enhanced radio link with an identity to be 4 on the auxiliary carrier according to the obtained information.

The step of the Node B synchronously reconfiguring the enhanced radio link with an identity to be 4 on the auxiliary carrier refers to: a Node B commanding the terminal to synchronously reconfigure an enhanced radio link on the auxiliary carrier.

As informed of the carrier attribute information of the radio link, the Node B can indicate the terminal to synchronously reconfigure the enhanced radio link on the auxiliary carrier, thereby avoiding the defect that an non-serving uplink enhanced dedicated channel radio link can't be synchronously reconfigured, for there is no non-serving downlink high speed shared channel radio link in the existing technology.

### Example 7

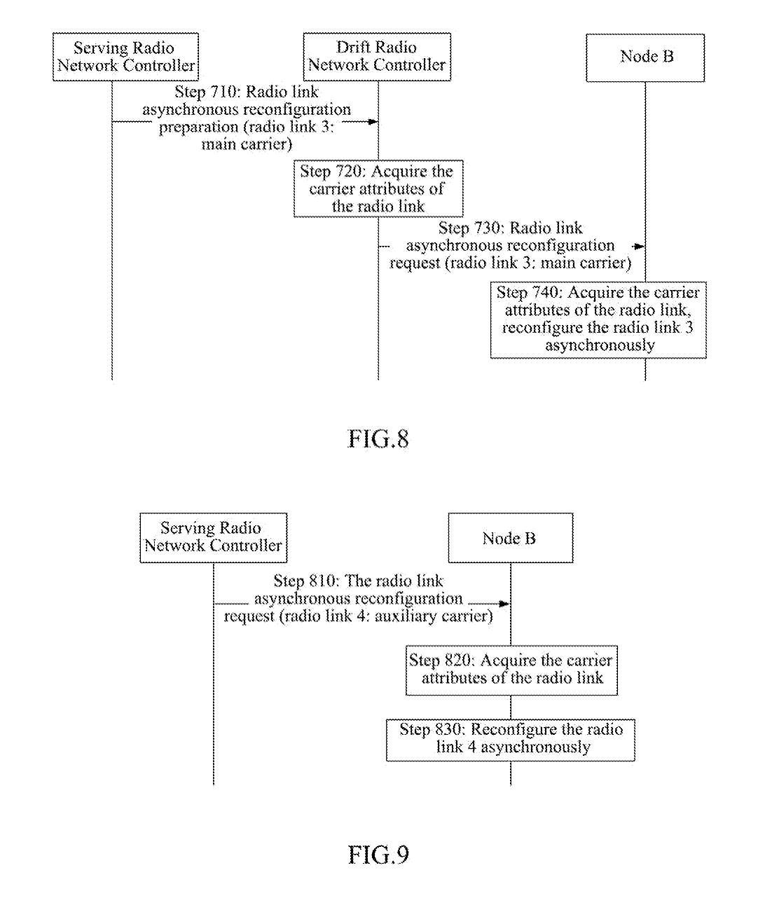

As shown in FIG. 8, the example 7 is a process of: when the radio link control process is a radio link asynchronous reconfiguration process, a serving radio network controller (SRNC) sending a “radio link asynchronous reconfiguration preparation” signaling to a drift radio network controller (DRNC) through RNSAP protocol layer via an IUR interface, and the DRNC sending a “radio link asynchronous reconfiguration request” signaling to a Node B through NBAP protocol layer via an IUB interface, which comprises the following steps.

Step 710: when performing the radio link asynchronous reconfiguration, a SRNC sends a radio link asynchronous reconfiguration preparation signaling to a DRNC, and informs the DRNC of the carrier attribute information of the carrier in which the asynchronously reconfigured enhanced radio link is located and the identity information of the enhanced radio link to be reconfigured;

in the example, the carrier attribute information of the carrier in which the enhanced radio link is located comprises a main carrier, and a radio link identity is 3. The radio link asynchronous reconfiguration preparation signaling indicates the DRNC to asynchronously reconfigure an enhanced radio link with an identity to be 3 on the main carrier.

Step 720: the DRNC receives the “radio link asynchronous reconfiguration preparation” signaling, obtains the carrier attribute and the identity information of the radio link therein, and constructs a “radio link asynchronous reconfiguration request” signaling.

Step 730: the DRNC sends the “radio link asynchronous reconfiguration request” signaling including the carrier attribute and the identity information of the radio link to the Node B, and indicates the Node B to asynchronously reconfigure the enhanced radio link;
the radio link asynchronous reconfiguration request signaling indicates the Node B to asynchronously reconfigure the enhanced radio link with an identity to be 3 on the main carrier.

Step 740: the Node B asynchronously reconfigures the enhanced radio link with an identity to be 3 on the main carrier after receiving the “radio link asynchronous reconfiguration request” signaling.

The step of the Node B asynchronously reconfiguring the enhanced radio link with an identity to be 3 on the main carrier refers to: a Node B commanding the terminal to asynchronously reconfigure an enhanced radio link on the main carrier.

As informed of the carrier attribute information of the radio link, the Node B can indicate the terminal to asynchronously reconfigure the enhanced radio link on the main carrier, thereby avoiding the defect that an non-serving uplink enhanced dedicated channel radio link can't be asynchronously reconfigured, for there is no non-serving downlink high speed shared channel radio link in the existing technology.

### Example 8

As shown in FIG. 9, the example 8 is a process of: when the radio link control process is a radio link asynchronous reconfiguration process, a serving radio network controller (SRNC) sending a “radio link asynchronous reconfiguration request” signaling to a Node B through NBAP protocol layer via an IUB interface, which comprises the following steps.

Step 810: when performing the radio link asynchronous reconfiguration, a SRNC sends a “radio link asynchronous reconfiguration request” signaling, and informs the Node B of the carrier attribute information of the carrier in which the asynchronously reconfigured enhanced radio link is located and the identity information of the enhanced radio link to be reconfigured;
in the example, the carrier attribute information of the carrier in which the enhanced radio link is located comprises an auxiliary carrier, and a radio link identity is 4. The radio link asynchronous reconfiguration request signaling indicates the Node B to asynchronously reconfigure an enhanced radio link with an identity to be 4 on the auxiliary carrier.

Step 820: the Node B receives the “radio link asynchronous reconfiguration request” signaling, and obtains the carrier attribute and the radio link identity therein.

Step 830: the Node B asynchronously reconfigures the enhanced radio link with an identity to be 4 on the auxiliary carrier according to the obtained information.

The step of the Node B asynchronously reconfiguring the enhanced radio link with an identity to be 4 on the auxiliary carrier refers to: a Node B commanding the terminal to asynchronously reconfigure an enhanced radio link on the auxiliary carrier.

As informed of the carrier attribute information of the radio link, the Node B can indicate the terminal to asynchronously reconfigure the enhanced radio link on the auxiliary carrier, thereby avoiding the defect that an non-serving uplink enhanced dedicated channel radio link can't be asynchronously reconfigured, for there is no non-serving downlink high speed shared channel radio link in the existing technology.

The control system for implementing the above method comprises: a radio network controller and a non-serving Node B.

The radio network controller is configured to: inform a non-serving Node B to which the terminal belongs of the carrier attribute information of the enhanced radio link in a process of a non-serving cell performing a control of an enhanced radio link on a terminal using dual carrier high speed packet access technology;
the non-serving Node B is configured to: implement a control on the enhanced radio link according to the carrier attribute information.

The example of present invention also provides a radio network controller, which is configured to:
inform a non-serving Node B to which the terminal belongs of carrier attribute information of the enhanced radio link in a process of a non-serving cell performing a control of an enhanced radio link on a terminal using dual carrier high speed packet access technology, so that the non-serving Node B implements the control of the enhanced radio link according to the carrier attribute information.

When the radio network controller is a Serving Radio Network Controller (SRNC), the SRNC is further configured to: send carrier attribute information of the enhanced radio link to a Drift Radio Network Controller (DRNC) through a radio link management signaling of Radio Network Subsystem Application Part (RNSAP) protocol layer via an Interconnection of RNC (IUR) interface, so that the DRNC informs a non-serving Node B to which the terminal belongs of the carrier attribute information of the enhanced radio link, and
when the radio network controller is a DRNC, the DRNC is further configured to: send the carrier attribute information of the enhanced radio link to a non-serving Node B through a radio link management signaling of Node B Application Part (NBAP) protocol layer via an Interconnection of type B (IUB) interface.

The radio network controller is configured to: inform the non-serving Node B of the carrier attribute information of the enhanced radio link according to the following ways:
a serving radio network controller sending the carrier attribute information of the enhanced radio link to the non-serving Node B through the radio link management signaling of the Node B Application Part (NBAP) protocol layer via an Interconnection of type B (IUB) interface.

The carrier attribute information is configured to indicate that a carrier in which the enhanced radio link is located belongs to a main carrier or an auxiliary carrier in a dual carrier.

The radio network controller is further configured to: inform the non-serving Node B of identity information of the enhanced radio link to be controlled.

It should be noted that: the examples of the present invention and each feature in the examples can be combined mutually and can all fall into the protection scope of the present invention if there are no conflicts. Furthermore, the steps shown in the flow chart of the drawings can be executed in the computer system such as a group of computer executable instructions; moreover, the flow chart shows the logical sequence, but the shown or described steps can be executed by a sequence which is different from the logical sequence herein in certain conditions.

### Industrial Applicability

The present invention performs the transmission and acquisition of the carrier attribute information of the radio link between the radio access network control entities through including the carrier attribute information of a specified radio link in the signaling of the radio link control process, so that the terminal can establish an uplink enhanced dedicated channel according to the carrier attribute information of the radio link, and solve the practicable application of the dual carrier technology in the special scenarios by tiny modifications, thereby avoiding the defects in the existing technology and making the dual carrier high speed packet access technology practicable.

What is claimed is:

1. A method for controlling non-serving uplink enhanced radio link of dual carrier system, comprising:
in a process of a non-serving cell performing a control of an enhanced radio link on a terminal using dual carrier high speed packet access technology, a radio network controller informing a non-serving Node B to which the terminal belongs of carrier attribute information of the enhanced radio link; and
the non-serving Node B performing the control of the enhanced radio link according to the carrier attribute information.

2. The method according to claim 1, wherein:
the step of the radio network controller informing the non-serving Node B of the carrier attribute information of the enhanced radio link comprises:
a serving radio network controller sending the carrier attribute information of the enhanced radio link to a drift radio network controller through a radio link management signaling of Radio Network Subsystem Application Part (RNSAP) protocol layer via an Interconnection of RNC (IUR) interface; and
the drift radio network controller sending the carrier attribute information of the enhanced radio link to the non-serving Node B through a radio link management signaling of Node B Application Part (NBAP) protocol layer via an Interconnection of type B (IUB) interface.

3. The method according to claim 1, wherein:
the step of the radio network controller informing the non-serving Node B of the carrier attribute information of the enhanced radio link comprises:
a serving radio network controller sending the carrier attribute information of the enhanced radio link to the non-serving Node B through a radio link management signaling of Node B Application Part (NBAP) protocol layer via an Interconnection of type B (IUB) interface.

4. The method according to claim 1, wherein:
the carrier attribute information is configured to indicate that a carrier in which the enhanced radio link is located belongs to a main carrier or an auxiliary carrier in a dual carrier.

5. The method according to claim 1, wherein:
when the control process is a radio link establishment process, the control performed by the non-serving Node B for radio link is: establishing the enhanced radio link.

6. The method according to claim 1, wherein:
when the control process is a radio link increment process, the control performed by the non-serving Node B for radio link is: increasing the enhanced radio link.

7. The method according to claim 1, wherein:
when the control process is a radio link synchronous reconfiguration process, the control performed by the non-serving Node B for radio link is: reconfiguring the enhanced radio link synchronously.

8. The method according to claim 1, wherein:
when the control process is a radio link asynchronous reconfiguration process, the control performed by the non-serving Node B for radio link is: reconfiguring the enhanced radio link asynchronously.

9. The method according to claim 1, wherein:
in the step of the radio network controller informing the non-serving Node B to which the terminal belongs of the carrier attribute information of the enhanced radio link, the radio network controller further informs the non-serving Node B of identity information of the enhanced radio link to be controlled.

10. A system for controlling non-serving uplink enhanced radio link of dual carrier system, comprising a radio network controller and a non-serving Node B, wherein:
the radio network controller is configured to: inform the non-serving Node B to which the terminal belongs of carrier attribute information of an enhanced radio link in a process of a non-serving cell performing a control of the enhanced radio link on a terminal using dual carrier high speed packet access technology;
the non-serving Node B is configured to: implement the control of the enhanced radio link according to the carrier attribute information.

11. A radio network controller, which is configured to:
inform a non-serving Node B to which a terminal belongs of carrier attribute information of an enhanced radio link in a process of a non-serving cell performing a control of the enhanced radio link on the terminal using dual carrier high speed packet access technology, so that the non-serving Node B implements the control on the enhanced radio link according to the carrier attribute information.

12. The radio network controller according to claim 11, wherein:
when the radio network controller is a Serving Radio Network Controller (SRNC), the SRNC is further configured to: send the carrier attribute information of the enhanced radio link to a Drift Radio Network Controller (DRNC) through a radio link management signaling of Radio Network Subsystem Application Part (RNSAP) protocol layer via an Interconnection of RNC (IUR) interface, so that the DRNC informs the non-serving Node B to which the terminal belongs of the carrier attribute information of the enhanced radio link; and
when the radio network controller is a DRNC, the DRNC is further configured to: send the carrier attribute information of the enhanced radio link to the non-serving Node B through a radio link management signaling of Node B Application Part (NBAP) protocol layer via an Interconnection of type B (IUB) interface.

13. The radio network controller according to claim 11, wherein:
the radio network controller is configured to inform the non-serving Node B of the carrier attribute information of the enhanced radio link according to following ways:
a serving radio network controller sending the carrier attribute information of the enhanced radio link to the non-serving Node B through a radio link management signaling of Node B Application Part (NBAP) protocol layer via an Interconnection of type B (IUB) interface.

14. The radio network controller according to claim 11, wherein:
the carrier attribute information is configured to indicate that a carrier in which the enhanced radio link is located belongs to a main carrier or an auxiliary carrier in a dual carrier.

15. The radio network controller according to claim 11, wherein:
the radio network controller is further configured to: inform the non-serving Node B of identity information of the enhanced radio link to be controlled.

16. The radio network controller according to claim 12, wherein:
the carrier attribute information is configured to indicate that a carrier in which the enhanced radio link is located belongs to a main carrier or an auxiliary carrier in a dual carrier.

17. The radio network controller according to claim 13, wherein:
the carrier attribute information is configured to indicate that a carrier in which the enhanced radio link is located belongs to a main carrier or an auxiliary carrier in a dual carrier.

18. The radio network controller according to claim 12, wherein:
the radio network controller is further configured to: inform the non-serving Node B of identity information of the enhanced radio link to be controlled.

19. The radio network controller according to claim 13, wherein:
the radio network controller is further configured to: inform the non-serving Node B of identity information of the enhanced radio link to be controlled.
